(19) United States
(12) Patent Application Publication
(10) Pub. No.: US 2019/0089191 A1
(43) Pub. Date: Mar. 21, 2019

(54) POWER SUPPLY SYSTEMS FOR SERVERS

(71) Applicant: Hewlett Packard Enterprise Development LP, Houston, TX (US)

(72) Inventors: Mark Isagani Bello Rivera, Cypress, TX (US); Stephen Airey, Houston, TX (US); Mohamed Amin Bemat, Cypress, TX (US); David P. Mohr, Spring, TX (US); Daniel Humphrey, Cypress, TX (US)

(21) Appl. No.: 15/710,916

(22) Filed: Sep. 21, 2017

(51) Int. Cl. H02J 9/06; G06F 1/30; H02J 7/00; H02J 7/34

(52) U.S. Cl. CPC H02J 9/062; H02J 7/345; H02J 7/0072; G06F 1/30

(57) ABSTRACT

Examples herein relate to a power supply system for a server. The system comprises a primary source, a power interface and a direct current (DC) energy supply chargeable by the primary source through the power interface. The primary source to power the server through the power interface and in the event of failure of the primary source, the DC energy supply powers the server through the power interface. The DC energy supply is located inside the server on a cool side of the server.

### BACKGROUND

A power supply unit (or PSU) can convert alternating-current (AC) electric power supply to low-voltage regulated DC power for the internal components of a server, i.e. server load. Some power supply systems can provide power to a server from a primary source and from a secondary source if the primary source fails for data persistence. Examples of power supply systems that provide data persistence by using a central energy storage can be e.g. uninterruptible power supply (UPS) solutions for datacenters, or a rack level UPS. An UPS can be defined as an electrical apparatus that provides emergency power to a load when the input power source or mains power fails.

### BRIEF DESCRIPTION OF THE DRAWINGS

The following detailed description references the drawings, wherein:

FIG. 1 illustrates an example of power supply system for a server according to the present disclosure.

FIG. 2 illustrates an example of a power supply system for a server according to the present disclosure.

FIG. 3 illustrates an example of a power supply system for a server according to the present disclosure.

FIG. 4 illustrates a flowchart of an example method for supplying power to a server according to the present disclosure.

FIG. 5 illustrates a flowchart of another example method for supplying power to a server according to the present disclosure.

### DETAILED DESCRIPTION

Some power supply systems for servers as e.g. datacenter wide UPS solutions, or rack level UPS solutions can utilize central energy storage but can consume more real estate and lead to over-provisioning. Other solutions may provide internal storage of energy, but they may lack scalability, flexibility and allocate stored energy in a high temperature area within the server. These limitations affect the application and the reliability of the conventional power supply systems.

Furthermore, many users process large amounts of volatile data which the users require to persist through a power loss. These users may only require a high level of persistence on a small percentage of their datacenter servers. Instead of over-provisioning backup energy for the whole datacenter as used in the aforementioned UPS systems, the present disclosure presents a dual input power supply system to sustain specific servers in the event of a power loss to provide data persistence.

Hence, a power supply system is proposed to provide power to a server from a primary input connector and from a secondary input connecter if the primary power source fails. The secondary source is stored energy. The secondary source is replenished from the primary source through the power supply. The secondary source is located on a cool side of the server so the life of the source can be extended.

The proposed power supply system provides power to the system as well as providing a flexible input for backup energy. In addition, the supply may recharge the backup energy source. This solution provides power in a reliable way to maximize life of the energy storage and ensure volatile data may be backed up in the event of a primary power source fault. Volatile data stored on a volatile memory, contrary to non-volatile memory, is computer memory that requires power to maintain the stored information, it retains its contents while powered on but when the power is interrupted, the stored data is lost immediately or very rapidly.

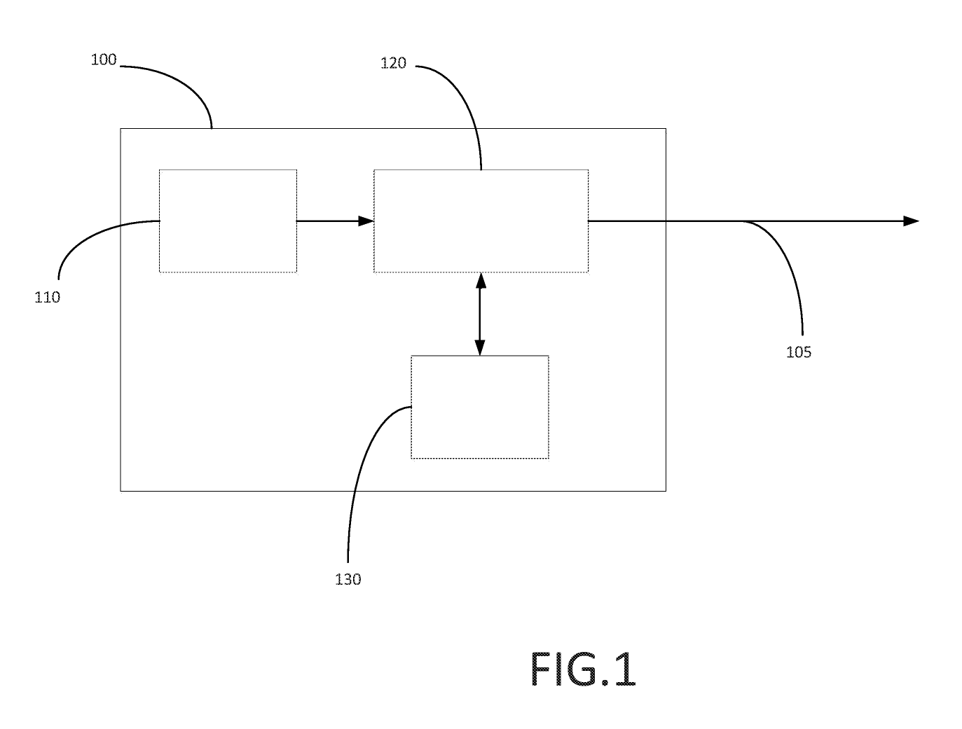

FIG. 1 shows an example power supply system 100 for a server according to the present disclosure. The power supply system 100 comprises a primary source 110, a power interface 120 and a direct current (DC) energy supply 130 chargeable by the primary source 110 through the power interface 120. The primary source 110 can power a server load (not shown in the figure) through the power interface 120 and via the output connector 105. In the event of failure of the primary source 110, the DC energy supply 130 can power the server (load) through the power interface 120 and via the output connector 105. In this example, the DC energy supply 130 is located on a cool side of the server to extend the lifecycle of the DC energy supply. A cool side of the server can be e.g. a front side of the server or a top side of the server.

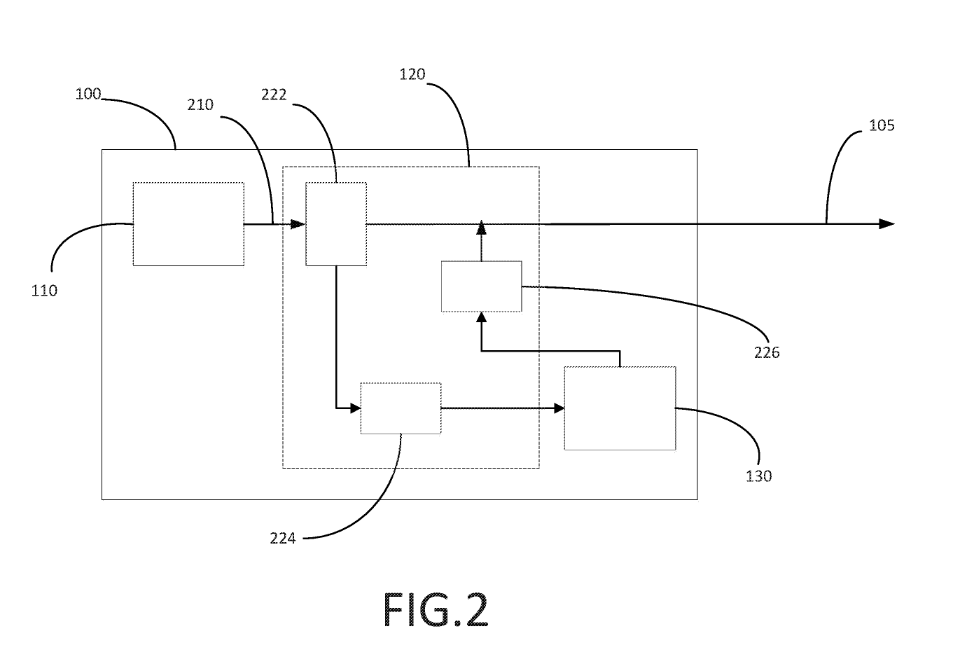

FIG. 2 shows the example power supply system 100 for a server. In this example, the power interface 120 is shown in more detail. The power supply system 100 again comprises the primary source 110 and the DC energy supply 130. The DC energy supply 130 may be any energy storage device which can be located on a cool side of the server and that is capable of providing sufficient stored energy for the system load to be able to back up volatile data to a persistent data storage device (not shown in the server) and that can be part of the server. The DC energy supply 130 can be e.g. batteries, capacitors or a combination thereof. The DC energy supply 130 can be defined as an energy storage device comprising capacitors, super capacitors and/or batteries. The DC energy supply 130 may not be required to power the server (load) in absence of failure of the primary source 110 in the power supply system 100. The primary source 110 can be one of a DC primary source or an AC primary source. The power interface 120 comprises a charger DC/DC converter 224 to charge the DC energy supply 130 with current from the primary source 110. The DC/DC converter is an electronic circuit that converts the current from the primary source 110 from one voltage level to another.

Furthermore, the power interface 120 also comprises a primary converter 222 that receives input current from the primary source 110 via connector 210 to provide DC current to the server (load) via output connector 105 and to provide DC current to the charger DC/DC converter 224. The primary converter 222 can convert either an AC input current or a DC input current from the primary source 110 into a suitable DC current to the server (load) and to the DC/DC converter 224. Hence, the DC energy supply 130 can be charged with an input AC or DC current from the primary source 110 through the primary converter 222 and the charger DC/DC converter 224 as shown in FIG. 2.

The charger DC/DC converter, may or may not be isolated and can convert the power which powers the server (main output of the AC/DC primary converter 222) to a voltage/current profile customized to the charge profile of DC energy supply 130. Furthermore, the power interface 120 also comprises a discharger DC/DC converter 226 to automatically discharge the DC energy supply 130 and to provide regulated DC current to the server (load) in the event of failure of the primary source 110.

The discharger 226 may connect directly to the output voltage via connector 105. The discharger DC/DC converter, may or may not be isolated and can convert the voltage/current of the DC energy supply 130 (battery supply) to a regulated voltage suitable for consumption by the server. The DC energy supply 130 may have a unique charge/discharge profile which must be comprehended by the charger DC/DC converter 224 and the discharger DC/DC converter 226.

In some implementations if the DC energy supply 130 is at a higher voltage than the primary source 110, it may connect to the power supply at its bulk capacitance to overcome the voltage difference and a regulating function to maintain a constant voltage level may be implemented in the discharger 226 DC/DC converter 226.

Hence, the DC energy supply 130 can be discharged with the discharger DC/DC 226 when the primary source 110 (or any additional redundant primary source) is not able to provide power.

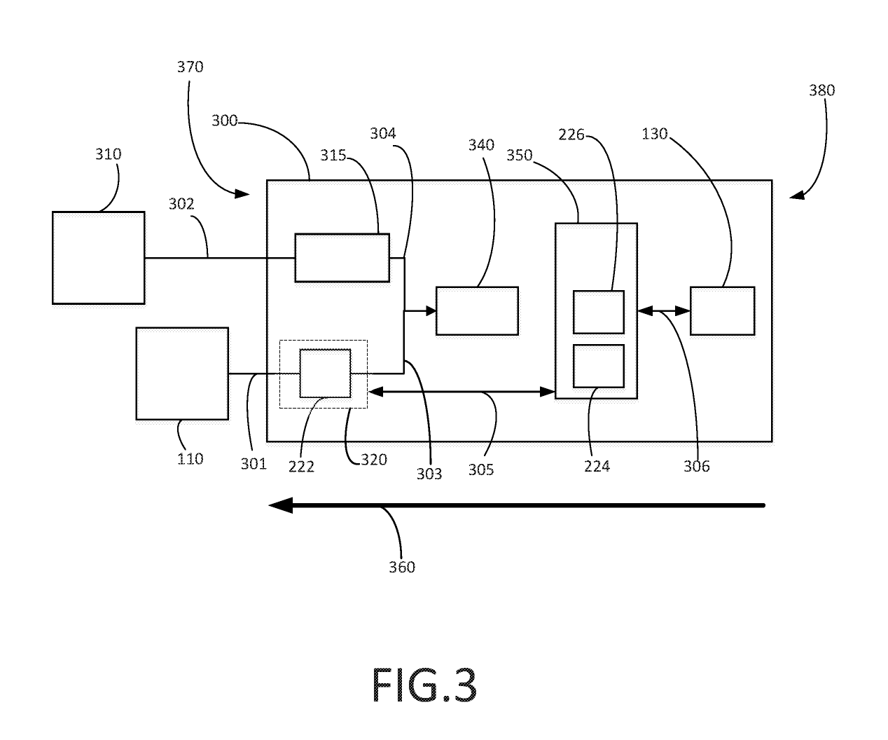

FIG. 3 shows an example server 300 comprising an example power supply system according to this disclosure. In particular, the server 300 comprises the DC energy supply 130 and a power interface 320 comprising the primary converter 222 previously shown in FIG. 2 that receives input current from the primary source 110 associated with the server 300 via a connector 301.

The primary converter 222 provides DC current to the server load 340 via output connector 303 and provides DC current to the charger DC/DC converter 224 established on a backplane 350 comprised in the server 300. The backplane 359 is an electronic circuit board containing circuitry and sockets into which the charger DC/DC converter 224 can be plugged in. In this regard, the backplane 350 also comprises the discharger DC/DC 226.

The backplane can be define as an interface for the DC energy supply 130 input/output through the charger DC/DC converter 224 and the discharger 226 DC/DC converter 226, respectively. In other implementations, the charger and/or discharger may not be located on the backplane. If the charger and/or discharger are located on the backplane 350, then the server main power for the load is present on the backplane and the backplane 350 can perform as the charger's input and/or the discharger's output. If the charger and discharger are not located on the backplane, then the server main power may not be required to be present on the backplane.

Hence, FIG. 3 shows an example configuration having a backplane for the charger DC/DC converter 224 and the discharger DC/DC 226 which differs from the one shown in FIG. 2. In particular, the backplane 350 mates with the DC energy supply 130 and is connected to the DC energy supply 130 via connector 306 allowing the charger and the discharger to carry out the previously-mentioned functions with the DC energy supply 130.

The power supplies in a server are generally located in the rear side of the server shown by arrow 370 and they may be exposed to significantly pre-heated air. This provides a poor environment for most dense energy storage devices which can damage the cycle life of the storage devices. The example server 300 shown in FIG. 3 and the example power supply system establishes the DC energy supply 130 on a cool side of the server 300 as e.g. in the front side of the server 300 shown by arrow 380 and hence, avoiding pre-heated air and therefore extending the cycle life of the devices. In this respect, in this example, the DC energy supply 130 device is a battery pack which resides in space normally reserved for hard disk drives within the server 300.

Furthermore, an additional power source 310 supplying the server 300 and a redundant power supply 315 comprised in the server 300 to receive power from the power source 310 are shown in FIG. 3. In this example, the redundant power supply 315 can function as a first level of redundancy in an event of failure of the primary source 110 and/or the additional power source 310 and the DC energy supply 130 can function as a second level of redundancy in a second event of failure in the system. The redundant power supply 315 can be a DC/DC or an AC/DC power supply. The duplication of the power supply can increase reliability of the server system, usually in the form of a backup or fail-safe, or to improve actual system performance.

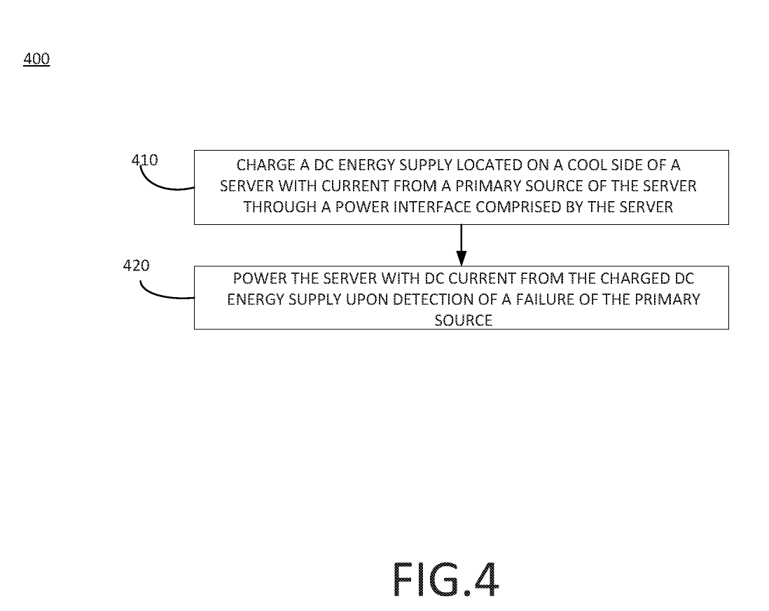

FIG. 4 shows a flowchart of an example method 400 for supplying power to a server according to the present disclosure. The method 400 comprises a step 410 for charging a DC energy supply. The DC energy supply can be located on a cool side of the server to extend the lifecycle of the DC energy supply (see reference 130 in FIGS. 1 to 3). The DC energy supply can be charged with current from a primary source (see reference 110 in FIGS. 1 to 3) of a server through a power interface (see reference 120 in FIGS. 1 to 2) comprised by the server. The DC energy supply 130 can be defined as an energy storage device comprising capacitors, super capacitors and/or batteries.

The method 400 comprises a step 420 for powering the server with DC current from the charged DC energy supply upon detection of a failure of the primary source. In some implementations, the method 400 can comprise a step for backing up volatile data stored in the server with the DC energy supply.

In some implementations the flowchart 400 further comprises a step for powering the server with current from the primary source with a primary converter (see reference 222 in FIG. 2) comprised in the power interface and a step for charging the DC energy supply with current from the primary source through a DC/DC charger (see reference 224 in FIG. 2 and FIG. 3).

In some implementations the flowchart 400 further comprises a step for providing regulated DC current to power the server with DC current from the DC energy supply in the event of failure of the primary source through a discharger DC/DC converter (see reference 226 in FIG. 2 and FIG. 3).

In some implementations the flowchart 400 further comprises a step for establishing the discharge DC/DC converter and the charger DC/DC converter on a backplane, and a step for connecting or mating the DC energy supply to the backplane as shown in FIG. 3.

In some implementations the flowchart 400 further comprises a step for establishing in the server an additional power source (see reference 310 in FIG. 3) and a redundant power supply for the additional power source (see reference 315 in FIG. 3), and a step for configuring the redundant power supply as a first level of redundancy in an event of failure of the primary power source and a step for configuring the DC energy supply as a second level of redundancy in a second event of failure in the system. The duplication of the power supply can increase reliability of the server system, usually in the form of a backup or fail-safe, or to improve actual system performance.

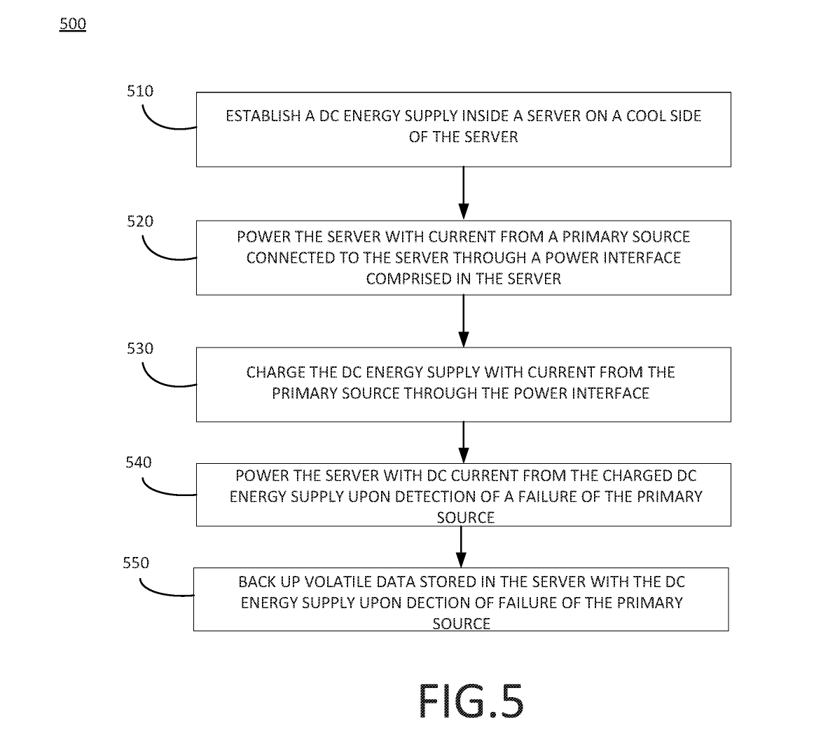

FIG. 5 shows a flowchart of an example method 500 for supplying power to a server according to the present disclosure.

The method 500 comprises a step 510 for establishing the DC energy supply inside the server on a cool side of the server. A cool side of the server can be e.g. a front side of the server or a top side of the server. The DC energy supply can power the server (load) through an additional power interface. In some implementations, the additional power interface can be e.g. a backplane which may present the server main power. The DC energy supply 130 may capable of providing sufficient stored energy for the system load to be able to back up volatile data to a persistent data storage device comprised in the server. As previously mentioned, the DC energy supply 130 can be e.g. batteries, capacitors or a combination thereof.

The method 500 comprises a step 520 for powering the server with current from the primary source through a main power interface comprised in the server. The primary source can power a server load through a main power interface (as shown in FIG. 3, reference 320).

The method 500 comprises a step 530 for charging the DC energy supply with current from the primary source through a DC/DC charger. The DC/DC charger, may or may not be isolated and can convert the power which powers the server (main output of an AC/DC converter connected to the primary source, see FIG. 2 and reference 222) to a voltage/current profile customized to the charge profile of the DC energy supply. In some examples, the DC/DC charger can be established on the backplane.

The method 500 comprises a step 540 for powering the server with DC current from the charged DC energy supply upon detection of a failure of the primary source. In an implementation, a discharger DC/DC converter can be used to power the server with DC current from the charged DC energy supply. In some examples, the discharger DC/DC converter can be established on a backplane. If the charger and/or discharger are located on the backplane, then the server main power for the load is present on the backplane and the backplane can perform as the charger's input and/or the discharger's output. If the charger and discharger are not located on the backplane, then the server main power may not be required to be present on the backplane.

Additionally, the method 500 comprises a step 550 for backing up volatile data stored in the server with the DC energy supply upon detection of a failure of the primary source.

Relative terms used to describe the structural features of the figures illustrated herein are in no way limiting to conceivable implementations. It is, of course, not possible to describe every conceivable combination of components or methods, but one of ordinary skill in the art will recognize that many further combinations and permutations are possible. Accordingly, the present disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements.

1. A power supply system for a server, the system comprising:
a primary source;
a power interface; and
a direct current (DC) energy supply chargeable by the primary source through the power interface,
wherein the primary source powers the server through the power interface, and
wherein in the event of failure of the primary source, the DC energy supply powers the server through the power interface, and
wherein the DC energy supply is located inside the server on a cool side of the server.

2. The power supply system of claim 1, wherein the primary source is one of a DC primary source or an alternating current (AC) primary source.

3. The power supply system of claim 2, wherein the power interface comprises a charger DC/DC converter to charge the DC energy supply with current from the primary source.

4. The power supply system of claim 3, wherein the power interface comprises a primary converter that receives input current from the primary source to:
provide DC current to the server; and
provide DC current to the charger DC/DC converter.

5. The power supply system of claim 4, wherein the power interface comprises a discharger DC/DC converter to provide regulated DC current to the server from the DC energy supply in the event of failure of the primary source.

6. The power supply system of claim 5, further comprising a backplane,
wherein the charger DC/DC converter and the discharger DC/DC converter are established on the backplane, and
wherein the backplane is connected to the DC energy supply.

7. The power supply system of claim 1, wherein the DC energy supply is a battery, a capacitor or a combination thereof.

8. The power supply system of claim 1, wherein in the event of failure of the primary source, the DC energy supply discharging causes the backup of volatile data stored in the server.

9. The power supply system of claim 1, further comprising an additional power source and a redundant power supply for the additional power source,
wherein the redundant power supply functions as a first level of redundancy in an event of failure of the primary power source, and
wherein the DC energy supply functions as a second level of redundancy in a second event of failure in the system.

10. The power supply system of claim 9, wherein the redundant power supply is a DC/DC converter sourced by a battery or a capacitor or an AC/DC source.

11. A method, the method comprising:
charging a DC energy supply with current from a primary source of a server through a power interface comprised by the server;
powering the server with DC current from the charged DC energy supply upon detection of a failure of the primary source,
wherein the DC energy supply is located inside the server on a cool side of the server.

12. The method of claim 11, further comprising
powering the server with current from the primary source with a primary converter comprised in the power interface.

13. The method of claim 11, further comprising:
charging the DC energy supply with current from the primary source through a DC/DC charger comprised in the power interface.

14. The method of claim 11, further comprising:
providing regulated DC current to power the server with DC current from the DC energy supply in the event of failure of the primary source through a discharge DC/DC converter comprised in the power interface.

15. The method of claim 14, further comprising:
establishing the discharge DC/DC converter and the charge DC/DC converter on a backplane, and
connecting the DC energy supply to the backplane.

16. The method of claim 11, further comprising:
establishing in the server an additional power source and a redundant power supply for the additional power source.

17. The method of claim 16, further comprising
configuring the redundant power supply as a first level of redundancy in an event of failure of the primary power source, and
configuring the DC energy supply as a second level of redundancy in a second event of failure in the system.

18. The method of claim 11, further comprising:
backing up volatile data stored in the server with the DC energy supply.
